(19) United States
(12) Patent Application Publication
(10) Pub. No.: US 2012/0296918 A1
(43) Pub. Date: Nov. 22, 2012

(54) Credibility Information in Returned Web Results

(75) Inventors: Meredith June Morris, Bellevue, WA (US); Julia Schwarz, Pittsburgh, PA (US)

(73) Assignee: Microsoft Corporation, Redmond, WA (US)

(21) Appl. No.: 13/110,117

(22) Filed: May 18, 2011

(51) Int. Cl. G06F 17/30

(52) U.S. Cl. 707/748; 707/E17.084

(57) ABSTRACT

The subject disclosure is directed towards using credibility-related data in conjunction with servicing a web request such as a search query or a request for page content. The credibility-related data may be used to convey information to a user indicative of a level of credibility, such as to view credibility information with each search result, or in association with returned web page content. The credibility-related data may be used to rank, re-rank and/or filter search results. Also described is extracting credibility-related feature data from search-related data and web pages, and using the feature data with a dataset of credibility-rated pages to learn/train relative feature weights in a credibility model used by the search engine.

### BACKGROUND

The internet provides people with access to an immense amount of information. While much of the content is valuable, some of the content is incorrect and misleading. Indeed, the presence (and, sometimes, prominence) of incorrect and misleading content on the internet can have serious consequences for people who use information found online as the basis for their decisions. Example topics in which such content may be consequential or even harmful include topics related to health, politics, and financial advice.

However, a significant amount of users naïvely believe or at least innately trust that contemporary search engines are somehow configured to not return such content, which is simply not correct. When dealing with the internet, some users put aside what is referred to as the “healthy skepticism” that they would otherwise employ when dealing in other contexts. Any technology that helps users deal with such issues is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which credibility-related data is accessed in conjunction with servicing a web request, and used convey information to a user indicative of a level of credibility associated with at least some of the response data returned in response to the web request. For example, if the web request corresponds to a search query, the credibility-related data may be used to render a credibility visualization associated with each search result (e.g., credibility-related statistics, or an indication that no credibility information is available). If the web request corresponds to a request for page content (of a URL), the credibility-related data may be returned as credibility information that is useable for rendering as a credibility visualization associated with the page content.

In one alternative aspect, the credibility-related data may be used to rank or re-rank search results based upon the credibility-related data. This may be instead of or in addition to a credibility visualization associated with each search result.

The returned credibility information may comprise popularity data such as pagerank data, general popularity data and/or expert-related data. The returned credibility information may comprise at least one award or certification given to at least one site or domain corresponding to a search result or page content. Geographic data (where a site was clicked) and/or timing data may be returned as part of the credibility information.

In one aspect, a credibility mechanism is learned/trained based upon credibility features extracted from search-related data and web documents. The credibility features may include on-page features (e.g., spelling data, recency data, domain type data, and/or advertising data), off-page features (e.g., award data, certification data, pagerank data, page parent site rank data, search engine ranking data, sharing data, user feedback data, click data, and/or bookmark data) or aggregate features (e.g., general popularity data, popularity data based upon demographic data, dwell time data, re-visitation data and/or expert popularity data).

In one aspect, upon receiving credibility information associated with search results in response to a query, a visible representation of at least part of the credibility information may be rendered in association with rendered search results. Upon receiving credibility information associated with page content in response to a request for page content, and a visible representation of at least part of the credibility information may be rendered in association with rendered web page content.

In one aspect, there is described processing search-related data and web page data to extract credibility feature data related to credibility of web pages. A dataset comprising credibility-rated pages is used to learn relative weights of the corresponding credibility features. This processing is performed in order to provide a credibility model based upon the relative weights of the credibility features.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for re-ranking search results based upon credibility information.

FIG. 2 is a block diagram representing example components for showing search results or page content accompanied by credibility information.

FIG. 3 is an example representation of how search results may be augmented with credibility-related information.

FIG. 4 is an example representation of how page content may be augmented with credibility-related information.

FIG. 5 is a flow diagram representing example steps for using credibility information to re-rank search results returned in response to a query.

FIG. 6 is a flow diagram representing example steps for augmenting search results with credibility information in response to a search query.

FIG. 7 is a flow diagram representing example steps for augmenting page content with credibility information in response to a page request.

FIG. 8 shows an illustrative example of a computing environment into which various aspects of the present invention may be incorporated.

### DETAILED DESCRIPTION

Various aspects of the technology described herein are generally directed towards using web page features and other information (e.g., related to user “expertise”) to obtain credibility information for web pages. This credibility information may then be used to help prevent users from relying on incorrect or misleading content.

In one aspect, the credibility information may be used implicitly (from the user's perspective) by a search engine to rank or re-rank search results based upon a credibility score or the like. Another aspect allows search engine users to filter search results based on various statistics indicative of credibility, such as site popularity. In another aspect, the credibility information may be used explicitly, by presenting users with visual information that assists users in making more informed decisions about the quality of web content that is available. For example, credibility-related information may be displayed alongside search results, and/or in a browser toolbar or the like so that users can visualize credibility in conjunction with web content.

It should be understood that any of the examples herein are non-limiting. For example, additional features beyond those described herein may be used, and various techniques for using/visualizing credibility information (e.g., audio-based) may be alternatively provided. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and search technology in general.

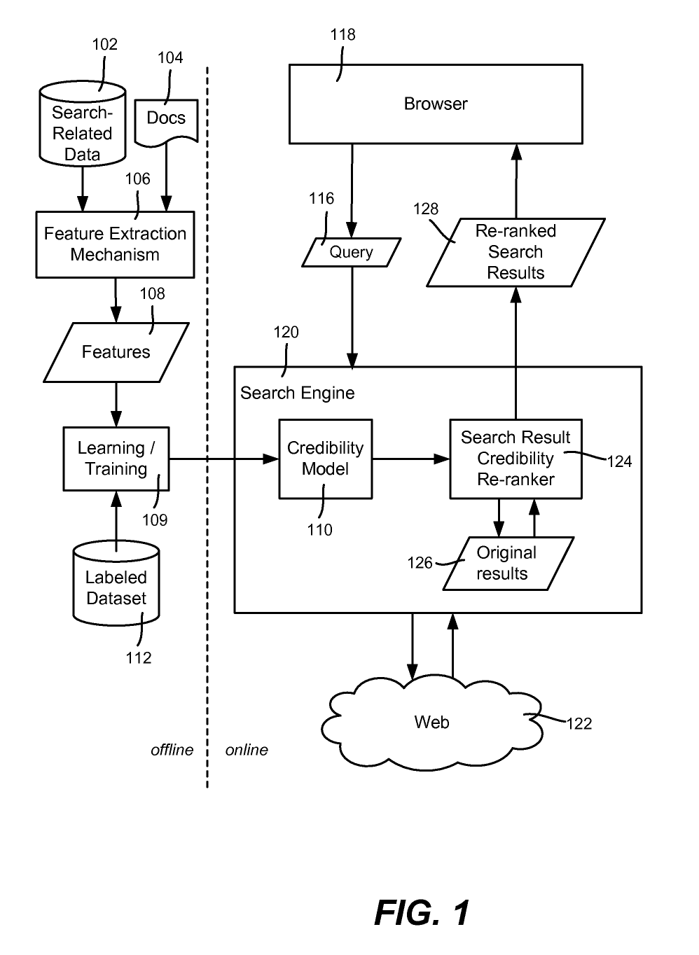

FIG. 1 is a block diagram showing example components of one system for using credibility-related information in search technology. In an offline training phase, search-related data 102 and associated web documents 104 are processed by a feature extraction mechanism 106 to extract features 108 that have been deemed to have some relationship to credibility. For example, toolbar data, browser data, search engine log data, social network data and/or other data may be used as the search-related data 102 to obtain various feature data regarding the documents 104 (pages) users visit.

Via training/machine learning (block 109), a credibility model 110 or the like that has relative feature weights and/or otherwise uses the features may be learned based upon a labeled dataset 112 of web pages, e.g., those that have been labeled with a “ground truth” credibility score. An alternative is to manually develop the credibility model (or at least part of the credibility model), such as by a team of topical experts/paid curators and/or through human computation/crowdsourcing. In general, in one implementation a credible webpage is considered as one whose information can be accepted as the truth without needing to look elsewhere. If one can accept information on a page as true at face value, then the page is credible; if one needs to go elsewhere to check the validity of the information on the page, then the page is less credible. These concepts may be used to provide a range of rating values that may be used to score web pages, for example.

For example, to create such a dataset 112, web pages may be scored for credibility by manual reviewing, e.g., rating from a score of one for “very non-credible” to a score of five for “very credible.” Such training/machine learning based on a “ground truth” dataset is well known in other areas of web search, such as relevance ranking, and is not described in detail herein.

To further ensure reliability, ratings from topic experts may be used in conjunction with and/or to verify the labeled dataset 112. Note that while assigning credibility ratings is to some extent a subjective process, comparisons with a sample of topical specialists' ratings indicate that a well-labeled dataset 112 provides a reasonable approximation of expert opinion on the credibility of web pages. In one implementation, training/machine learning with this dataset 112 determines the relative weights of the extracted features 108 in the credibility model 110.

Turning to additional details on some example features that may be used for credibility assessment, various on-page, off-page, and aggregate features that relate to web pages' credibility may be used. For example, to compute credibility ratings for web pages using weighted combinations of features, on-page features (e.g., spelling errors, advertising, domain type, recency of updating) may be selected for use. Off-page features such as awards, pagerank, sharing and bookmarking also may be selected. Aggregate features such as popularity, geographic reach, dwell time, re-visitation patterns, and expert popularity also may be selected.

On-Page features are present on a page but are difficult or time-consuming for a person to attend to or quantify. These include spelling errors, advertising (e.g., the number of advertisements on a page), and domain type (e.g., .com, .gov, or the like) of a page. Note that with domain type, users tend to focus on the page contents rather than the browser's address bar. Another example of an on-page feature that may be used the reading level of a page, e.g., computed based upon vocabulary, sentence structure and so forth, wherein in general, pages with a higher reading level may be considered more credible than those with a lower reading level.

Off-page features refer to information that is not present on the target page. Note that such features (such as popularity among specialized user groups) may be difficult or impossible for end-users to obtain or assess, yet are available to search providers and provide signals regarding credibility that may be valuable. Such features include information about what awards and certifications a site has received from various agencies that provide such information. Examples include how many “Webby Awards” a site has received, the Alexa rank of a site (based upon popularity) and Health on the Net (HON) which certifies/provides awards to reliable health-related Web sites. The presence and absence of such awards may be used as features and/or as supplemental information provided to users as described below.

Pagerank is another off-page feature, which may be gathered for each URL in the data set. Note that a web page's pagerank is not generally visible to end-users, unless they install browser toolbars or look up URLs on dedicated sites such as those run by search engine optimization companies. The rank of a URL's parent site may also be a feature, such as when the pagerank for a particular page is unavailable. A related feature is a search engine's ranking of the URL for the queries used in generating the data set.

Sharing is another off-page feature, referring to how frequently a URL was shared (obtained using publicly available sharing and click information). In addition to public statistics about sharing, another sharing feature (assuming user login/access to social network data) is based upon personalized sharing data, e.g., how often this page was shared or visited by people that the user knows and trusts). User feedback data such as the number of times a link to a webpage was shared, liked, commented on, and clicked from a social networking site, as well as the number of times a shortened version of the URL was clicked, also may be used as features. Another feature is the number of users that bookmarked a URL.

Aggregate features are not generally available to end users, and correspond to information collected by search engines that often log user behavior, e.g., via browser toolbars. One aggregate feature is general popularity, obtained by counting the number of unique user identifiers (IDs) visiting the page in a given period. To approximate the popularity of a page among a broad demographic, the number of different geographic locations visitors to the site originated may be computed, e.g., using zip code information.

Dwell time, referring to the average length of time users kept a URL open in their browser, is used as a proxy for the amount of time spent viewing a page, and may be another aggregate feature. Further, a user returning to a page can be considered as an indication of that page's quality, and a measure of such re-visitation patterns may be used as a feature, e.g., by calculating on average how often a page was re-visited.

Another aspect is expert popularity, based on the fact that not everybody is able to evaluate credibility equally well. For example, people unfamiliar with a topic, such as medicine, have little opportunity to evaluate the earned credibility of a given medical site because they have spent little time on medically-related websites. Topic experts are known to be more effective searchers in their expertise area because they use previously-encountered, high-quality URLs as starting points, and thus behavior of experts within a particular domain provides a useful source of information regarding credibility. Expert popularity may be computed using user profiles from search engines/social networks, and/or by using user behavior (whitelisted page visits)

For example, U.S. published patent application no. 20100088331, assigned to the assignee of the present invention and hereby incorporated by reference, describes a heuristic-based approach to defining expertise (users who visit a set of white-listed URLs identified by a professional in the target topic area) that is effective at differentiating users according to several standards of expert behavior. Based on this technology, the user IDs in the log data may be classified with respect to expertise in various topic areas in the URL data set. For example, users who visited any of the whitelisted sites in a particular topic area more than some number (e.g., ten) times are more likely to be “experts” in that topic. Using this metric, the number of topic experts who had visited each page in the data set in the period covered by the log data may be calculated and used as feature data.

Once the feature data are collected and processed, the various features may each be given different weights based upon their correlation with web pages that have been labeled with a “ground truth” credibility score in the labeled dataset 112. The resulting credibility model 110 may be used to compute a credibility score (or set of scores and/or other data) for an unknown page, which may be used as a factor in initially ranking search results, or in re-ranking original search results, for example.

For example, in the implementation of FIG. 1 in the online phase, given an unknown query 116 from a browser 118, a search engine 120 may use the features of the pages crawled from the web 122 and the credibility model 110 to re-rank (block 124) the original results 126 based upon credibility considerations. The re-ranked search results 128 are then returned. Note that as described above, another way that a search engine may use credibility data is to use the data as input features that determine the original ranking, that is, the ranker is trained with many features, and some of those features comprise credibility-related feature data.

Another way that search engine users may filter search results is based on various statistics indicative of credibility, such as site popularity. For example, a user may filter search results to only show results from sites that have more than one million monthly users. This may be implemented as an advanced query operator.

If available for use in re-ranking the initial ranking of pages, end users may turn off the credibility-based ranking mechanism via a browser setting or the like, and/or use a slider bar or the like to set a level as to how much credibility-based re-ranking score is to be used as a factor in ranking. Alternatively, a user may interact to specifically request credibility based re-ranking, e.g., if the initial ranking was not based upon credibility considerations. A query can be accompanied with data that signals to the search engine if and/or how the credibility model is to be used.

It is noted that the search results may be re-ranked and/or filtered automatically by the search engine, whether by default or by pre-specified user preference data, before returning to the user. Alternatively, the search results that are returned may be re-ranked and/or filtered in response to a user-initiated request, e.g., a user can request that the search engine go back and re-rank and/or filter the results.

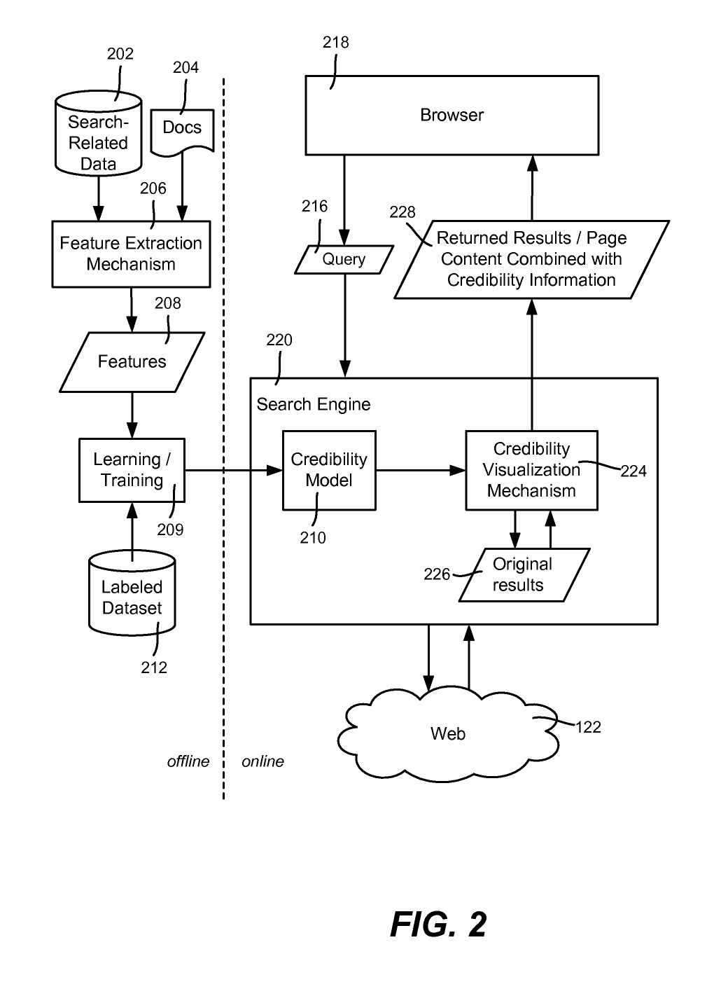

An alternative implementation represented in FIG. 2 uses the credibility model to modify how the returned information is displayed to the user, to allow the user to visualize and assess the credibility of content. In other words, the credibility information is rendered to end-users in a way that allows them to make more informed web search clickthrough decisions. Note that the credibility model 210 used for displaying credibility information to users may be different from a model used for ranking or re-ranking. In general, the components of FIG. 2 (labeled “2xx” instead of “1xx”) are similar to or the same as those of FIG. 1, and thus and are not described in detail except to note different ways that credibility may be used with search results.

More particularly, when the set of original results 226 comprises a search results page, the credibility information may be provided by a credibility visualization mechanism 224 as visible data accompanying each search result (block 228). The search engine 220 may format the page with the results combined with credibility information, and/or the browser 218 may reformat the page based upon user preference data, for example.

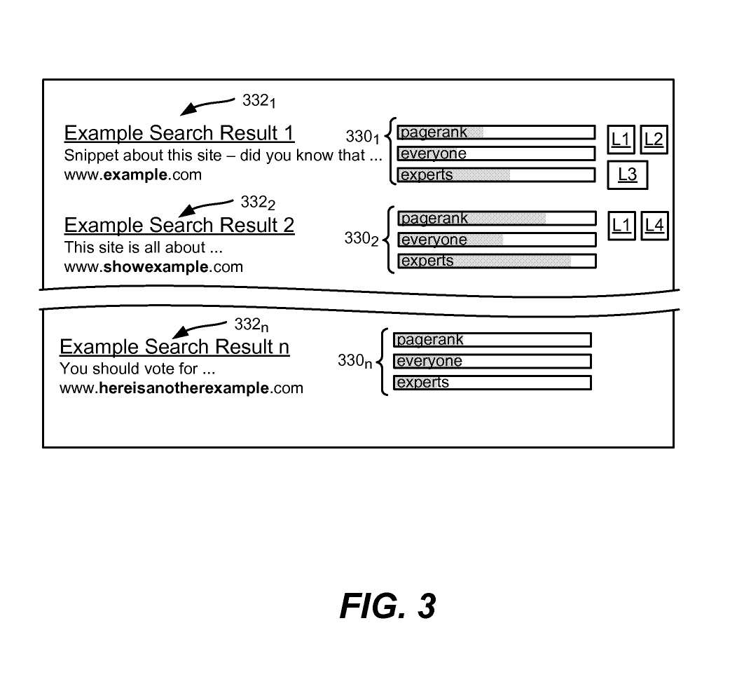

FIG. 3 shows one example of how information from the credibility model 210 may be used to represent a set of scores 330₁-330ₙ and other data (awards in the form of logos L1-L4, if any) with each search result 332₁-332ₙ. As can be seen, the user can see the credibility information accompanying each search result, and thus make a more informed decision on whether to click a given result. Other ways to display such information (e.g., below each result, on hovering over a search result, and so on) may be used.

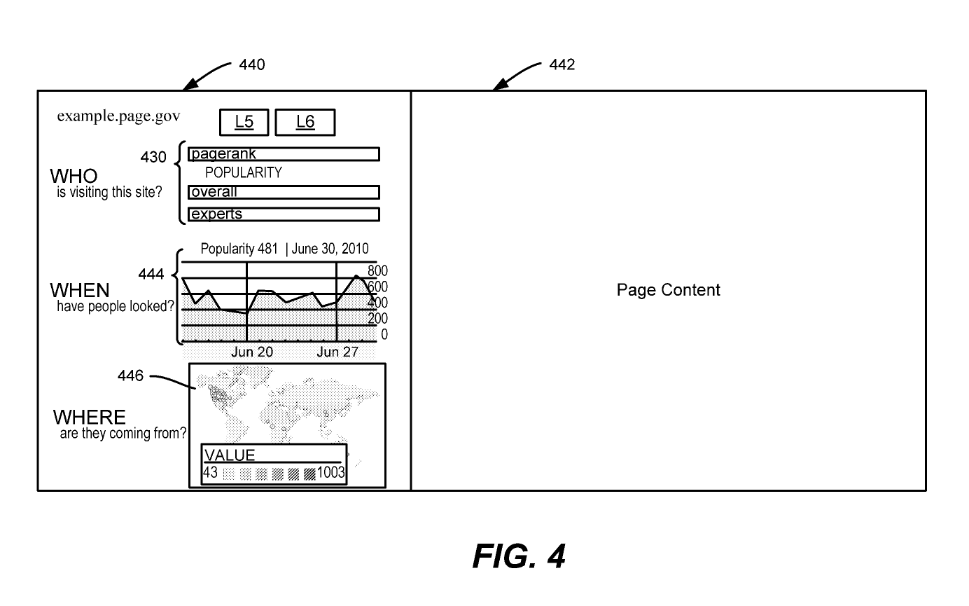

FIG. 4 shows an example of how credibility information 440 may be displayed in association with page content 442. In the example of FIG. 4, the credibility information is shown in the form of scores 430, a time-versus-popularity graph and data 444 and a geographic map 446 indicating the source of the page hits, (e.g., medical information on a page mostly accessed from a non-industrialized country may be considered more skeptically by users than that frequently accessed from an industrialized country, for example). As is understood, FIG. 4 is only one example. Alternatives include providing a credibility-related browser toolbar/plug-in that appears when visiting a web page, and so forth.

Note that while showing users all or most of the features gathered for each result or page provides the most information, showing a user too much information may not help people evaluate credibility. If too much is shown, not only is each of the features less prominent, but the clutter that results from so much information makes the entire augmentation less prominent on a page. Additionally, such an information-heavy intervention may distract users from their primary intent. Thus, the feature set may be reduced in size by measuring how well each feature correlates with the dataset, and/or not used in the display of credibility information to the user (at least not by default).

As seen in FIGS. 3 and 4, features with too low of a weight because of low correlation with the dataset (e.g., spelling errors) may be removed so as to not distract users with them. Features such as awards, although sparse, are included because of relatively high correlation. Features shown in FIGS. 3 and 4 as likely useful to users because of high correlation include overall/everyone's (general) popularity of a website, popularity of a site among domain experts, pagerank, the number of zip codes or the like from where people accessed a site, and receipt of awards and certifications.

Thus, the visualization of credibility information may use color and/or font size or other formatting to draw attention to a page's domain type, and may include logos (icons) to indicate whether a page has received awards or certifications. In the example of FIGS. 3 and 4, horizontal bars indicate the relative value of the current page's pagerank, general popularity, and popularity among experts for the page's topic (e.g., normalized based on the minimum and maximum values in the dataset). For page content (FIG. 4), overall popularity is further broken down to reveal temporal and geographic patterns in separate charts, e.g., grouped thematically according to the interrogative questions “who,” “when,” and “where.” The exemplified search result visualization (FIG. 3) is more compact than the web page visualization, to reflect space constraints, e.g., only items from the “who” category are shown in this condensed view example.

In alternative embodiments that display credibility information with search results or page content, different visualizations may be shown for different search or page categories (politics, health, and so on). Different demographic groups (children, adults, and the like) may be used, such as within an educational tool within a children's search engine. As can be readily appreciated, other ways to show such data may be used. A simple way may be to use color, e.g., green for likely credible, yellow for uncertain, red for likely not credible. A user may turn such information on or off, and/or may customize what is shown, e.g., the (pagerank, overall and expert) scores 430, but not the timing or geographic data, for example, as well as where the credibility information is shown relative to the page content.

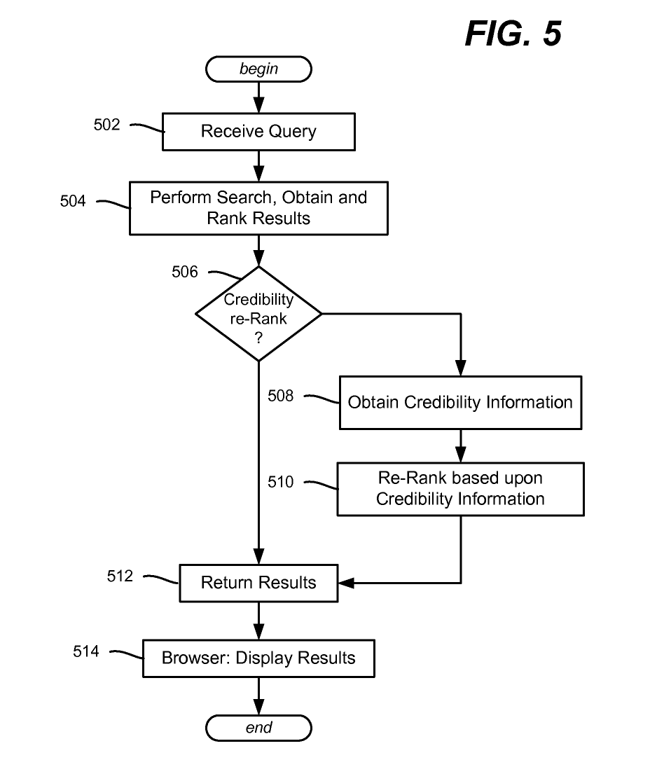

By way of summary, FIG. 5 is a flow diagram showing example steps of credibility based re-ranking of search results, beginning at step 502 where a query is received at a search engine. Step 504 represents performing the search, obtaining the results and ranking them, e.g., based upon relevance.

Step 506 represents determining whether to re-rank based upon credibility. This may be automatic, or turned on by default, however as mentioned above a user may turn off credibility based re-ranking. If on, step 506 branches to steps 508 and 510 where the credibility information is obtained from the credibility model (step 508), and used to re-rank the original results (step 510).

Step 512 represents returning the search results, e.g., the top ten search results, whether the original results or those re-ranked based upon credibility. Step 514 represents the browser rendering the returned results to the user. Note that the rendering of the browser need not change in this example, because the results inherently include credibility information via their ranking (although the browser may be modified to indicate whether credibility-based re-ranking is turned on or off). However, it is alternatively feasible to both re-rank based upon credibility as well as display credibility-related information to a user on a search results page. In this way, even a relatively highly-ranked result with a poor credibility score (e.g., because there are not many relevant results) is flagged as such to users.

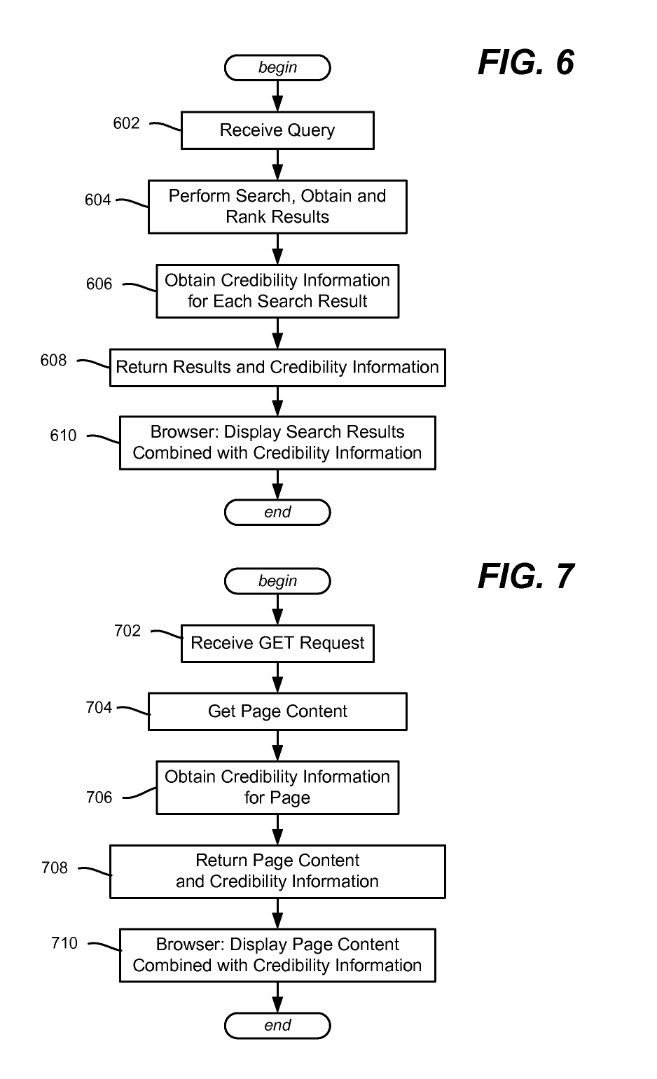

FIG. 6 is a summary of augmenting search results with credibility data in the form of example flow diagram steps, beginning at step 602 where a query is received. Step 604 is directed towards performing the search, obtaining the results and ranking them, e.g., based upon relevance.

Step 606 represents accessing the model to obtain credibility Information for each search result. Note that this may be a combination of somewhat static data for off-page and aggregate features, and dynamic data for on-page features extracted from the page directly.

Step 608 returns the results and credibility information. Step 610 represents the browser rendering the search results with the associated credibility information. As described above, the credibility information may be rendered (or not rendered) in accordance with user preferences, or based on how the search engine formats the page, e.g., with the credibility information accompanying each result.

FIG. 7 shows similar logic for visualizing credibility information with page content, beginning at step 702 where a “GET” request or the like is received that instructs the search engine to return a selected page. Step 704 represents obtaining the page content, with step 706 obtaining the credibility information for that page, again based upon a combination of on-page, off-page and aggregate features as appropriate.

Step 708 returns the page content and the associated credibility information. As described above, the credibility information may be rendered (or not rendered) by the browser at step 710 in accordance with user preferences, or by default, possibly in conjunction with how the search engine formats the page content.

As can be seen, FIGS. 6 and 7 present visualizations designed to augment search results and web pages, respectively, with credibility information, such as data representing the likely most useful features to users. In practice, such augmented search results and content are effective at increasing the accuracy of users' credibility assessments, in order to help people more accurately judge the credibility of online content.

### Exemplary Operating Environment

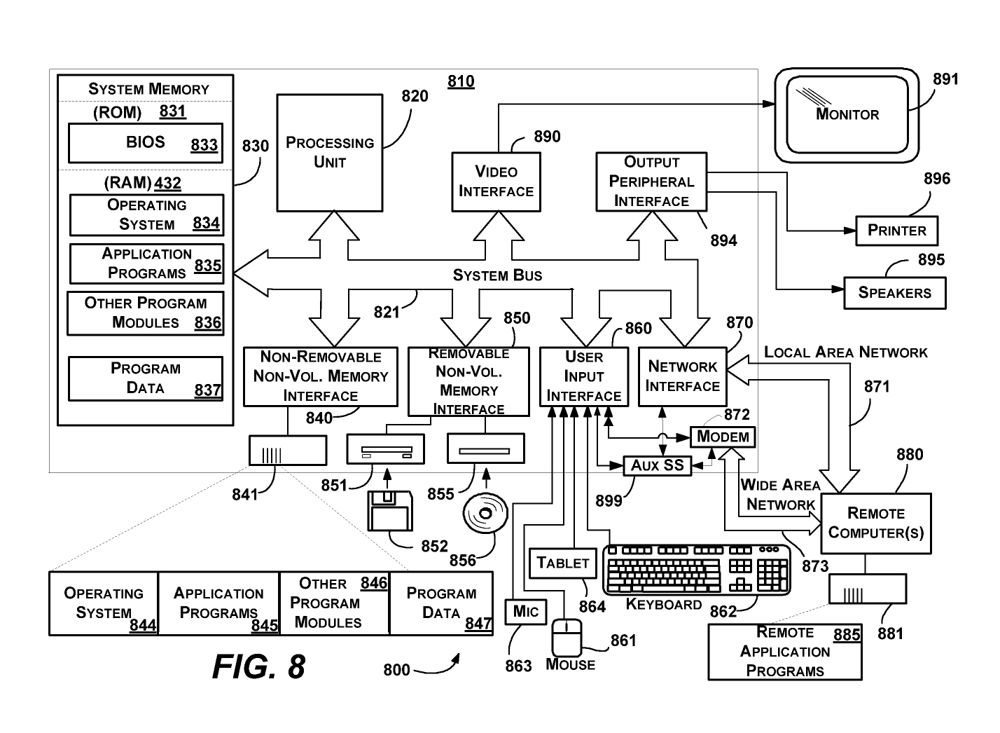

FIG. 8 illustrates an example of a suitable computing and networking environment 800 on which the examples of FIGS. 1-7 may be implemented. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 8, an exemplary system for implementing various aspects of the invention may include a general purpose computing device in the form of a computer 810. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media can be any available media that can be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 810. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 844, application programs 845, other program modules 846 and program data 847. Note that these components can either be the same as or different from operating system 834, application programs 835, other program modules 836, and program data 837. Operating system 844, application programs 845, other program modules 846, and program data 847 are given different numbers herein to illustrate that, at a minimum, they are different copies. A user may enter commands and information into the computer 810 through input devices such as a tablet, or electronic digitizer, 864, a microphone 863, a keyboard 862 and pointing device 861, commonly referred to as mouse, trackball or touch pad. Other input devices not shown in FIG. 8 may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. The monitor 891 may also be integrated with a touch-screen panel or the like. Note that the monitor and/or touch screen panel can be physically coupled to a housing in which the computing device 810 is incorporated, such as in a tablet-type personal computer. In addition, computers such as the computing device 810 may also include other peripheral output devices such as speakers 895 and printer 896, which may be connected through an output peripheral interface 894 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 871 and one or more wide area networks (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communications link between the computers may be used.

An auxiliary subsystem 899 (e.g., for auxiliary display of content) may be connected via the user interface 860 to allow data such as program content, system status and event notifications to be provided to the user, even if the main portions of the computer system are in a low power state. The auxiliary subsystem 899 may be connected to the modem 872 and/or network interface 870 to allow communication between these systems while the main processing unit 820 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
accessing credibility-related data in conjunction with servicing a web request; and
using the credibility-related data to convey information to a user indicative of credibility associated with response data returned in response to the web request.

2. The method of claim 1 wherein the web request corresponds to a search query, and wherein using the credibility-related data to convey the information to the user comprises returning the search results with credibility information that is useable for rendering as a credibility visualization associated with each search result.

3. The method of claim 2 wherein returning the search results with credibility information comprises returning pagerank data, general popularity data, or expert-related data, or any combination of pagerank data, general popularity data, or expert-related data in association with each search result.

4. The method of claim 2 wherein returning the search results with credibility information comprises returning data corresponding to at least one award or certification given to at least one site or domain corresponding to a search result.

5. The method of claim 1 wherein the web request corresponds to a search query, and wherein using the credibility-related data to convey the information to the user comprises ranking search results or filtering search results, or both ranking search results and filtering search results, based upon the credibility-related data for returning in response to the search query.

6. The method of claim 1 wherein the web request corresponds to a search query, and wherein using the credibility-related data to convey the information to the user comprises re-ranking or filtering search results, or both re-ranking search results and filtering search results, based upon the credibility-related data into re-ranked search results for returning in response to the search query.

7. The method of claim 1 wherein the web request corresponds to a request for page content, and wherein using the credibility-related data to convey the information to the user comprises returning the page content with credibility information that is useable for rendering as a credibility visualization associated with the page content.

8. The method of claim 7 wherein returning the page content with credibility information comprises returning data corresponding to at least one award or certification given to at least one site or domain corresponding to the page content.

9. The method of claim 7 wherein the web request corresponds to a request for page content, and wherein using the credibility-related data to convey the information to the user comprises returning the page content with credibility information that is useable for rendering as a credibility visualization associated with the page content.

10. The method of claim 9 wherein returning the page content with credibility information comprises returning popularity-related data in association with the page content.

11. The method of claim 10 wherein returning the popularity-related data comprises returning pagerank data, general popularity data, or expert-related data, or any combination of pagerank data, general popularity data, or expert-related data in association with the page content.

12. The method of claim 1 further comprising, extracting credibility-related features from search-related data and web documents, and processing the credibility-related features into the credibility-related data.

13. The method of claim 1 further comprising processing user profile data, social network data or user behavior data, or any combination of user profile data, social network data or user behavior data, into at least part of the credibility-related data.

14. In a computing environment, a system comprising, a search engine, the search engine configured to process search queries by returning search results and to process requests for content by returning pages, the search engine further configured to access a credibility mechanism to return credibility information with search results or web pages, or both, the credibility mechanism based upon credibility features extracted from search-related data and web documents.

15. The system of claim 14 wherein the credibility features include on-page features, off-page features or aggregate features, or any combination of on-page features, off-page features or aggregate features.

16. The system of claim 14 wherein the credibility features include spelling data, recency data, domain type data, reading level data, or advertising data or any combination of spelling data, recency data, domain type data, reading level data or advertising data.

17. The system of claim 14 wherein the credibility features include award data, certification data, pagerank data, page parent site rank data, search engine ranking data, sharing data, user feedback data, click data, or bookmark data, or any combination of data, certification data, pagerank data, page parent site rank data, search engine ranking data, sharing data, user feedback data, click data, or bookmark data.

18. The system of claim 14 wherein the credibility features include general popularity data, popularity data based upon demographic data, dwell time data, re-visitation data or expert popularity data, or any combination of general popularity data, popularity data based upon demographic data, dwell time data, re-visitation data or expert popularity data

19. The system of claim 14 further comprising, receiving credibility information associated with search results in response to a query and rendering a visible representation of at least part of the credibility information in association with rendered search results, or receiving credibility information associated with page content in response to a request for page content and rendering a visible representation of at least part of the credibility information in association with rendered web page content.

20. One or more computer-readable media having computer-executable instructions, which when executed perform steps, comprising:
processing search-related data and web page data to extract credibility feature data related to credibility of web pages;
using a dataset comprising credibility-rated pages to learn relative weights of credibility features; and
providing a credibility model based upon the relative weights of the credibility features.
